(19) United States
(12) Patent Application Publication
(10) Pub. No.: US 2020/0367076 A1
(43) Pub. Date: Nov. 19, 2020

(54) METHOD OF EXCHANGE OF INFORMATION BETWEEN RADIO REMOTE UNIT AND BASEBAND UNIT IN 4G LTE NETWORK WHEN LOSS OF SYNCHRONOUS SIGNALS ON COMMON PUBLIC RADIO INTERFACE

(71) Applicant: VIETTEL GROUP, Ha Noi City (VN)

(72) Inventors: Thi Diem Lam, Ha Noi City (VN); Viet Long Nguyen, Ha Noi City (VN); Dang Tung Nguyen, Ha Noi City (VN); Chi Linh Nguyen, Ha Noi City (VN); Tuan Duc Vu, Ha Noi City (VN)

(73) Assignee: VIETTEL GROUP, Ha Noi City (VN)

(21) Appl. No.: 16/732,015

(22) Filed: Dec. 31, 2019

(30) Foreign Application Priority Data
May 16, 2019 (VN) 1-2019-02553

(51) Int. Cl. H04W 24/04; H04L 15/00; H04L 1/24

(52) U.S. Cl. CPC H04W 24/04; H04L 1/24; H04L 15/00

(57) ABSTRACT

Method of exchanging information between Radio Remote Unit (RRU) and Baseband Unit (BBU) in Evolved Node B (eNodeB) when there is loss of synchronization of the Common Public Radio Interface (CPRI), including a) listening on BBU Small Frequency Factor (SFP) interface; b) when RRU detects an CPRI asynchronous event within a time period, conducting a hardware and software uncertainties test including the CPRI status, frequency, temperature, voltage, current and Radio Frequency (RF) operation; c) RRU converts checked uncertainty into text string; d) encoding text string into Morse code as binary bits 0,1; e) sending binary bits to the BBU by SFP module optical signal turning on and off; f) received data at the BBU SFP interface is encoded to Morse code, convert Morse code to text and writing file; and g) periodically checking the received text strings, collating them with predefined error codes, and take necessary trouble shooting steps.

### TECHNICAL AREAS

The invention relates to the method of exchanging operation/status information between a radio remote unit and a baseband unit in Evolved Node B (abbreviated as eNodeB or eNB) that has been developed in case of loss of signal synchronization on the Common Public Radio Interface (CPRI) between these two blocks. In which, the signal used to transmit data is an optical signal and designed according to the protocol Morse code transmission.

### TECHNICAL STATUS OF THE INVENTION

EnodeB is an important architecture in the Long Term Evolution (LTE) mobile communication system. The architecture of LTE eNodeB consists of the Radio Remote Unit (RRU), the Baseband Unit (BBU), the transmission part and the control part. To ensure the operation of entire system, the RRU and BBU communicate with each other via the CPRI interface and a fiber optic cable. Types of data between the BBU and RRU are in-phase and Quadrature—IQ, Ethernet, High Level Link Control (HDLC). However, in order for the RRU and BBU to communicate with each other, the CPRI interface must ensure speed synchronization on both sides.

In some cases, the CPRI may be out of synchronization due to software, core operation on the BBU or RRU, broken optical wires or Small Form Factor module, frequency slippage compared to the initial calibration, etc. Once the CPRI is out of sync, the user equipment (UE) data processed at the RRU cannot be transferred back to the BBU, resulting in a loss of service across the system. If the reason for this loss of synchronization occurs on the BBU, the system administrator can troubleshoot and restore service operation somehow depending on the specific situation. If the fault is on the RRU, because the transmission line has been lost, it is impossible to issue an instruction to troubleshoot the problem on the RRU. The remedy may be to restart the RRU or to remove the RRU device to check. This has a great influence on the maintenance of the service, takes a lot of time and is costly because it has to replace the RRU, so cannot control the operation of the system.

The invention relates to addressing communication with the RRU in the event of an asynchronous occurrence to help the engineers quickly identify errors occurring on the system and provide timely troubleshooting guidance on the RRU or BBU by controlling the optical signal on the cable to send bit 0 and 1 according to the predefined code. It is therefore possible to decide whether to replace equipment such as SFP modules, fiber optic cable or even the RRU.

### TECHNICAL NATURE OF THE INVENTION

The purpose of the invention is to propose a solution that can exchange the operating status between the RRU and BBU, help engineer to quickly determine the operational status of the RRU in case of CPRI synchronization loss. Because the the BBU and RRU have only one communication channel, the CPRI communication standard is transmitted through the SFP port plugged into an optical cable. In case for any reason this communication channel is out of sync, the BBU will lose connection with RRU. Determining the operational status of the RRU is very important, helping the operator to quickly handle existing problems to reduce the rate of eNodeB suspension, lost service.

To achieve the above purpose, the invention proposes a solution for the RRU and BBU to be able to exchange information in case off irreparable CPRI loss from the BBU side; then it is necessary to identify the behavior of the RRU to provide the next treatment method. Since the transmission between the BBU and the RRU is done using the SFP module and fiber optic cable, the control of the optical signals into data bits 0 and 1 is entirely possible base on the signal switching on and off on the transmission line. These data bits can carry RRU operational status information to the BBU to identify errors that cause system outages. The data bits should be transmitted according to an appropriate code. The invention proposes using Morse code that is suitable for light communication.

The invention proposes a method of exchanging information between the RRU and BBU in eNodeB when there is an asynchronous signal of CPRI including the following:
a) Initiate a program to listen for information on the SFP port on the BBU
b) When the RRU detects a CPRI asynchronous occurrence for a specified period of time, the RRU conducts a test of hardware and software uncertainties including the CPRI status, frequency, temperature, voltage, current and operating information of the Radio Frequency (RF),
c) The RRU converts the checked uncertainty states into a text string,
d) The RRU encodes this text string into Morse code as data bits 0, 1,
e) The RRU sends bits 0, 1 to the BBU by turning on and off the optical signal on the SFP module
f) When the BBU receives the data at the SFP interface, it performs decode of data 0, 1 to Morse code, from Morse code to text string and writes to file, and,
g) Perform periodic checks of the text string received in the file, collate them with predefined error codes and take necessary troubleshooting steps.

### BRIEF DESCRIPTION OF THE FIGURES

FIG. 1 show the pulse pattern of the Morse code symbols transmitted between the RRU and BBU according to the invention method.

FIG. 2 is a diagram depicting the connecting block between the RRU and BBU according to the invention method.

FIG. 3 is a diagram depicting the design of the relationship between the SFP module and CPU of the RRU/BBU on the system according to the invention method.

### DETAILED DESCRIPTION OF THE INVENTION

As described in FIG. 3, in the SFP module, the signal used to turn off the optical link is called TX Disable and the signal used to determine whether or not the received optical signal is present is called RX LOS. Each of these signals is represented by chip's pin, which is also two bits of the status register 110 on the SFP. Therefore, there are two ways for the processor to read the status of these two signals, one is to read the logic level of the SFP pin, or to read the register 110 on the SFP module.

Each SFP module has two EEPROM memory regions with addresses 0xA0 and 0xA2, which are read/written by I2C bus. 0xA0 memory area is used to store SFP production information such as serial number, manufacture name, type name, specifications, etc. While the 0xA2 memory area is used to store SFP information during operation such as power, current, voltage, temperature and status. In status register 110 which is in memory 0xA2, bit 6 is the TX Disable bit and bit 1 is the RX LOS bit. When the TX optical cable or TX transmission block of SFP on the RRU side is broken, the RX LOS signal on the BBU will be turned on. Thus, when the TX Disable signal of the RRU is turned on, the RX LOS signal of the BBU will also turn on and vice versa. Bit 1 is interpreted as turning off the optical signal, bit 0 is turning on the optical signal.

Morse code is a kind of method of transmitting textual information by a series of information turned on and off by sound, light, etc. In the Morse code table, each character is represented by a unique string of a dot, “.”, and a dash, “-”. Where:
“.” is defined by 1 unit of time.
“-” is defined by 3 units of time.
The space between characters is 3 units of time.
The space between words is 7 units of time.
   The Morse code table used in the invention method is shown in the following Table 1:

TABLE 1

| No. | Character | Morse symbol |
|---|---|---|
| 1 | a | .- |
| 2 | b | -... |
| 3 | c | -.-. |
| 4 | d | -.. |
| 5 | e | . |
| 6 | f | ..-. |
| 7 | g | --. |
| 8 | h | .... |
| 9 | i | .. |
| 10 | j | .--- |
| 11 | k | -.- |
| 12 | l | .-.. |
| 13 | m | -- |
| 14 | n | -. |
| 15 | o | --- |
| 16 | p | .--. |
| 17 | q | --.- |
| 18 | r | .-. |
| 19 | s | ... |
| 20 | t | - |
| 21 | u | ..- |
| 22 | v | ...- |
| 23 | w | .-- |
| 24 | x | -..- |
| 25 | y | -.-- |
| 26 | z | --.. |
| 27 | 0 | ----- |
| 28 | 1 | .---- |
| 29 | 2 | ..--- |
| 30 | 3 | ...-- |
| 31 | 4 | ....- |
| 32 | 5 | ..... |
| 33 | 6 | -.... |
| 34 | 7 | --... |
| 35 | 8 | ----.. |
| 36 | 9 | -----. |
| 37 | End of line ‘\n’ | .-.- |
| 38 | End of message | .-.-. |

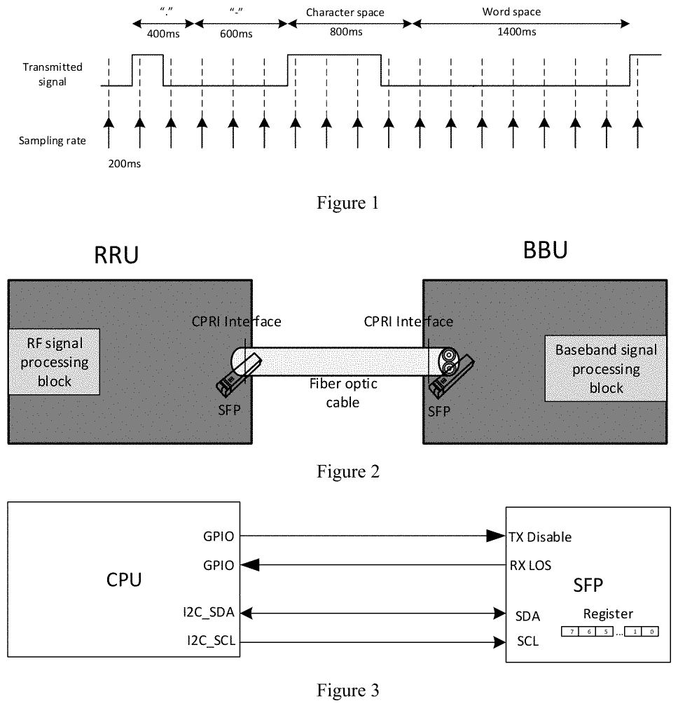

FIG. 1 shows the pulse of Morse symbols transmitted between the RRU and BBU according to the invention method. The TX Disable and RX LOS signal on most SFP types are usually updated within 100 milliseconds (ms) of change on pin. Therefore, the unit that holds the signal on the transmission line is decided to be 200 ms. Since the time unit that holds a logic level is 200 ms, the period it takes to send a unit “.” is 400 ms. The sampling period on the data decoding side to be able to receive a sufficient number of return signals shall comply with the Nyquist law and by a maximum of half the unit cycles of the signal being sent, and shall be chosen as 200 ms.

The transmission frame of message is defined as follows:

| | | | | | | | | |
|---|---|---|---|---|---|---|---|---|
| C | CS | C | . . . | CP | ES | C | . . . | E |

Where C is character, CS is character spacing, WS is word spacing, E is message ending character.

Based on FIG. 1, each dot character “.” will be represented by one unit of high pulse and 1 unit of low pulse, the total transmission time is 400 ms. Each dash symbol “-” will be represented by 3 units of high pulse and 1 unit of low pulse, so it takes the total transmission time of 800 ms. There must be a space after every character, represented by 3 low-pulse units of 600 ms. The smallest character is “e” with one dot symbol “.”. The largest character is “0” with 5 dash symbols “-”. Therefore, the calculated transmission speed is from 13 to 60 characters in one minute.

On the RRU, the software program that is responsible for sending Morse code will run at the time the monitoring program detects the CPRI synchronization status is lost for a period of 5 minutes. The Morse program first check the RRU's operating status, then converts the predefined errors into text format. After that, the program converts each character in the error text string into Morse code and finishes by sends the last character with the end of message character.

On the BBU, when the monitoring program detects the CPRI asynchronous state, it first performs a test of software, hardware and condition that ensures CPRI synchronization on the BBU and fixes it. In the event that abnormal states on the BBU are not detected, the monitoring program actives a Morse signal listening and decode program on the channel receiving data from the RRU. After the program reaches the end of the frame, all information will be saved to the file. The operator or operating program may rely on this RRU's operation status to conduct appropriate analysis, remediation and error correction activities.

### Example of the Inventions

In fact, the invention has been tested for feasibility and applied in the electronic laboratory for eNodeB development project of Viettel High Technology Industry Corporation as described in FIG. 2.

When there is no CPRI synchronous condition between the RRU and BBU, the BBU will execute the Morse code listener program. The program will check the RX LOS signal on the SFP every 200 ms, record the value obtained and proceed with Morse decoding. After decoding, the received text will be written to the file for the operator to read and process.

The RRU records the textual data to be sent to the BBU, performs Morse encoding into symbols “.”, “-” and switches the optical signal in a waveform as shown in FIG. 1. The performance of patent tests is performed using I2C lines that are not GPIO due to specific hardware designs. The results of the sending data are completely received. The operational status of the RRU is used for fault analysis on the RRU.

### THE ACHIEVED EFFECT OF THE INVENTION

The system established by the method of the invention is capable of communicating necessary data between BBU and RRU in case of CPRI loss. Instead of the engineer having to go to the field to check for errors on the RRU, then report to the system administrator and take corrective measures, with this method, the system operating engineer can check current faults that are happening on the RRU by data received from the RRU via Morse code. This helps to quickly identify a system failure on the RRU, sending an execution instruction to the RRU to quickly solve the current problem. At the same time, identifying errors also helps development engineers to save time to fix errors by conducting in parallel bug fixes right in the laboratory before replacing the RRU in case it is necessary.

What is claimed is:

1. A method of exchanging information between a Radio Remote Unit (RRU) and a Baseband Unit (BBU) in eNodeB when there is a loss of synchronization of the Common Public Radio Interface (CPRI) includes the following steps:
a) Initiate a program to listen for information on a port of an SFP module on the BBU
b) When the RRU detects a CPRI asynchronous condition within a specified period of time, the RRU conducts a test of hardware and software uncertainties including a CPRI status, a frequency, a temperature, a voltage, a current and an operation information of Radio Frequency (RF),
c) The RRU converts a result of test of the hardware and software uncertainties into a text string,
d) The RRU encodes this text string into Morse code in the form of data bits 0 and 1.
e) The RRU sends the bits 0, 1 to the BBU by turning on and off an optical signal on the SFP module,
f) When the BBU receives data at port on the SFP module, convert bits 0, 1 to Morse code, convert from Morse code to a text string and write said text string to a file, and
g) Perform a periodic check of the text strings received in the file, collate them with predefined error codes and take necessary troubleshooting steps.
